(19) United States
(12) Patent Application Publication
(10) Pub. No.: US 2011/0203830 A1
(43) Pub. Date: Aug. 25, 2011

(54) FOAM ELECTRIC WIRE

(75) Inventors: Hideki Kono, Osaka (JP); Rogerio Tocchetto, Plainfield, IN (US); Yoshihisa Yamamoto, Osaka (JP); Ronald Hendershot, Decatur, AL (US)

(73) Assignee: DAIKIN AMERICA, INC., Orangeburg, NY (US)

(21) Appl. No.: 13/125,847

(22) PCT Filed: Oct. 29, 2009
(86) PCT No.: PCT/US09/62503

§ 371 Date: Apr. 25, 2011

Related U.S. Application Data
(60) Provisional application No. 61/110,037, filed on Oct. 31, 2008.

(51) Int. Cl. H01B 7/00

(52) U.S. Cl. 174/120 C

(57) ABSTRACT

A foam electric wire is usable for plenum twisted pair cables, coaxial cables for CATV, cables for HDMI, coaxial cables for antenna wires in mobile communications, coaxial cables for medical applications, coaxial cables for security, and coaxial cables for broadband applications. The foam electric wire includes a conductor and a plurality of coating layers that coat the conductor and consist of perfluoro resin. At least one coating layer is an unexpanded layer. At least one coating layer is an expanded layer whose expansion percentage is 40% or greater. At least one coating layer contains a perfluoro polymer having an MFR of 1-50 g/10 min. The perfluoro polymer has a melt tension of 0.09 N or greater, and/or polymer terminals that are substantially only —CF₃.

### FIELD OF THE INVENTION

The present invention relates to foam electric wire.

### BACKGROUND INFORMATION

With the increased speed of communication in recent years, faster transmission of ever larger amounts of information is in demand. In communication cables, too, there is an increasing need for faster propagation velocities and smaller transmission losses. For example, the transmission speed of twisted pair cables for Internet usage has already increased from 100 Mbit/s to 1 Gbit/s, is currently 10 Gbit/s, and will increase to 40 Gbit/s in the next generation; consequently, the ability to transmit large quantities of information accurately and quickly is in demand.

Propagation velocity is expressed by V=Vc/(s)^{1/2}, transmission loss is expressed by α=K×{α1 (conductor loss)+α2 (dielectric loss)}, and dielectric loss is expressed by α2=k2(∈μ)^{1/2} tan δ×f. To increase the propagation velocity and decrease the transmission loss, there is a need to decrease a permittivity ∈ and a dielectric tangent tan δ of the coating part. One effective means to accomplish this is to increase the expansion of the coating part of the cable. Thereby, lowering the permittivity ∈ and the dielectric tangent tan δ can satisfy the demand for a cable with a fast propagation velocity and a small transmission loss.

Because fluororesin has excellent electrical characteristics and heat resistance, is noncombustible, and performs extremely well as an electric wire coating material, it is used in various electric wire applications. Principal applications include plenum twisted pair cables, coaxial cables for CATV, cables for HDMI, coaxial cables for antenna wires in mobile communications, coaxial cables for medical applications, coaxial cables for security, and coaxial cables for broadband applications.

When increasing the expansion of the coating part of the cable, especially when manufacturing a monolayer foam cable (i.e., electric wire) with an expansion percentage of 40% or greater, problems arise. For example, owing to outgassing and defoaming in the vicinity of the outer side surface of the insulation layer, a stable outer diameter cannot be obtained. Also, owing to defoaming in the vicinity of a conductor (i.e., a core wire), adhesion of the insulation layer to the conductor decreases. These problems both lower the stability of the outer diameter and the capacitance (i.e., the electrostatic capacitance) of the electric wire and degrade the characteristics of the electric wire necessary for it to function as a communication cable. SRL (Structure return loss) is one example of a decrease in such a characteristic. In addition, abnormal growth of the bubbles in the expanded layer causes an increase in the size of the bubbles, which also leads to a decrease in electrical characteristics such as variation in the impedance.

In addition, generally speaking, although long term production stability is desirable from the viewpoint of improving productivity, problems, such as defects in the cable's external appearance caused by the accumulation of foreign matter in the tip surface, or the die surface during the foam molding of fluororesin (hereinbelow, this phenomenon is sometimes called plate-out), sometimes occur. Consequently, it becomes necessary to frequently disassemble and clean the apparatus, which reduces productivity.

In particular, in the case of a cable that calls for a relatively fine electric wire and a relatively thin coating, manufacturing that electric wire with a high expansion percentage and superior electrical performance makes it difficult to also achieve high productivity.

### SUMMARY OF THE INVENTION

Therefore, an object of the present invention is to provide a foam electric wire that achieves a high propagation velocity and a low transmission loss and minimizes problems resulting from outgassing and defoaming.

Another object of the present invention is to provide a foam electric wire that does not incur plate-out on the tip surface or the die surface during manufacturing and can be molded in a stable fashion over a long period of time.

The foregoing objects can basically be achieved and the foregoing problems can basically be solved by using a foam electric wire that comprises a plurality of coating layers, and by using fluororesin for the coating layers.

In accordance with a first aspect of the present invention, a foam electric wire of the is provided that comprises:

a conductor; and
a plurality of coating layers that coat the conductor and consist of perfluoro resin;
wherein,
at least one layer of the plurality of coating layers is an unexpanded layer;
at least one layer of the plurality of coating layers is an expanded layer whose expansion percentage is 40% or greater; and
at least one layer of the plurality of coating layers contains the perfluoro polymer having an MFR of 1-50 g/10 min, and
the perfluoro polymer has
(1) a melt tension of 0.09 N or greater, and/or
(2) polymer terminals that are substantially only —CF₃.

The foam electric wire according to the first aspect of the present invention achieves a high propagation velocity and a low transmission loss and minimizes problems resulting from outgassing and defoaming. Additionally, a foam electric wire according to the first aspect has an excellent molding property.

More specifically, when the perfluoro polymer has a melt tension of 0.09N or higher, it is possible to prevent abnormal growth of a foam cell size and to reduce the thickness of an insulation layer.

Meanwhile, when the polymer terminals of the perfluoro polymer are substantially only —CF₃, the propagation velocity is high and the transmission loss is small.

A foam electric wire of a second aspect of the present invention, which is according to the first aspect of the present invention, is characterized by the expansion percentage of the entire plurality of coating layers being 40% or greater.

The foam electric wire according to the second aspect of the present invention achieves a particularly high propagation velocity and a particularly low transmission loss while also minimizing problems resulting from outgassing and defoaming.

A foam electric wire of a third aspect of the present invention, which is according to the second aspect of the present invention, is characterized by the outermost layer of the plurality of coating layers being an unexpanded layer.

The foam electric wire according to the third aspect of the present invention has superior capacitance stability, excellent external diameter stability, and a smooth surface.

A foam electric wire of a fourth aspect of the present invention, which is according to the third aspect of the present invention, is characterized by the thickness of the outermost layer of the plurality of coating layers being 2%-15% of the thickness of the entire plurality of coating layers.

The foam electric wire according to the fourth aspect of the present invention maintains a smooth coating surface even when the expansion percentage is high.

A foam electric wire of a fifth aspect of the present invention, which is according to any one of the first to fourth aspects of the present invention, is characterized by the innermost layer of the plurality of coating layers being an unexpanded layer.

The foam electric wire according to the fifth aspect of the present invention has superior capacitance stability and superior adhesion of the insulation layer to the conductor.

A foam electric wire of a sixth aspect of the present invention, which is according to any one of the first to fifth aspects of the present invention, is characterized by the plurality of coating layers consisting of three or more coating layers, wherein the innermost layer and the outermost layer thereof are unexpanded layers.

The foam electric wire according to the sixth aspect of the present invention does not incur plate-out on the tip surface or the die surface during manufacturing and can be molded in a stable fashion over a long period of time.

A foam electric wire of a seventh aspect of the present invention, according to any one invention of the first to sixth aspects of the present invention, is characterized by all layers of the plurality of coating layers containing the perfluoro polymer having an MFR of 1-50 g/10 min, and the perfluoro polymer having

(1) a melt tension of 0.09 N or greater, and/or
(2) polymer terminals that are substantially only —CF₃.

The foam electric wire according to the seventh aspect of the present invention achieves a high propagation velocity and a low transmission loss and minimizes problems resulting from outgassing and defoaming. Additionally, a foam electric wire having all layers of the plurality of coating layers containing the perfluoro polymer according to the seventh aspect has good formability.

More specifically, when the perfluoro polymer has a melt tension of 0.09N or higher, it is possible to prevent abnormal growth of a foam cell size and reduce the thickness of an insulation layer.

Meanwhile, when the polymer terminals of the perfluoro polymer are substantially only —CF₃, the propagation velocity is high and the transmission loss is small.

A foam electric wire of an eighth aspect of the present invention, which is according to the one to the seventh aspects of the present invention, is characterized by the perfluoro polymer having a melt tension of 0.09 N or greater and polymer terminals that are substantially only —CF₃.

With a foam electric wire according to the eighth aspect of the present invention, it is possible to prevent abnormal growth of a foam cell size and reduce the thickness of an insulation layer. Also, since the polymer terminals of the perfluoro polymer are substantially only —CF₃, the propagation velocity is high and the transmission loss is small.

A foam electric wire of the ninth aspect of the present invention, which is according to any one of the first to eighth aspects of the present invention, is characterized by the perfluoro polymer consisting of a TFE unit and an HFP unit.

A foam electric wire of the tenth aspect of the present invention, which is according to any one of the first to eighth aspects of the present invention, is characterized by the perfluoro polymer consisting of a TFE unit, an HFP unit, and a PFVE unit. A foam electric wire according to the tenth of aspect of the present invention has good formability.

A foam electric wire of the eleventh aspect of the present invention, which is according to any one of the first to eighth aspects of the present invention, is characterized by the perfluoro polymer consisting of the perfluoro polymer consists of a TFE unit and a PFVE unit.

A foam electric wire of the twelfth aspect of the present invention, which is according to any one of the first to eleventh aspects of the present invention, is characterized by the entire plurality of layers being manufactured using a coextruding method.

A foam wire in accordance with one or more of the above aspects of the present invention achieves a high propagation velocity and a low transmission loss and minimizes problems resulting from outgassing and defoaming.

In a foam electric wire where an outermost layer of the plurality of coating layers is an unexpanded layer in accordance with one or more of the above aspects of the present invention, a superior capacitance stability, an excellent external diameter stability, and a smooth surface are obtained.

In a foam electric wire where an innermost layer of the plurality of coating layers is an unexpanded layer in accordance with one or more of the above aspects of the present invention, a superior capacitance stability and superior adhesion of the insulation layer to the conductor are also obtained.

Besides, in a foam electric wire where an outer most layer and an innermost layer of the plurality of coating layers are unexpanded layers in accordance with one or more of the above aspects of the present invention, plate-out does not occur on the tip surface or the die surface during manufacturing and foam electric wires can be molded in a stable fashion over a long period of time.

### BRIEF DESCRIPTION OF THE DRAWINGS

FIG. 1 is a cross sectional schematic view of a foam electric wire according to one configuration of the present invention.

### DETAILED DESCRIPTION OF THE PREFERRED EMBODIMENTS

The present invention will now be explained in more detail.

A foam electric wire 15 of the present invention comprises

a conductor; and
a plurality of coating layers that coat the conductor and consist of perfluoro resin;
wherein,
at least one layer of the plurality of coating layers is an unexpanded layer;
at least one layer of the plurality of coating layers is an expanded layer whose expansion percentage is 40% or greater.

The insulation part in the foam electric wire 15 of the present invention consists of the plurality of coating layers, which form parts of an insulation part. The insulation part must comprise at least two layers: an unexpanded layer and an expanded layer.

Examples of a configuration of an insulation part (coating layers) made up of two layers, i.e., an unexpanded layer and an expanded layer, include: (1) a configuration in which an expanded layer is arranged on the conductor side (i.e., the inside) and an unexpanded layer is arranged on the outside of the expanded layer; and (2) a configuration in which an unexpanded layer is arranged on the conductor side (i.e., the inside) and an expanded layer is arranged on the outside of the expanded layer.

An insulation part which consists three layers, i.e., an unexpanded layer, an expanded layer, and an unexpanded layer, can be more effective than the examples having two layers mentioned above. An insulation part which consists of an even greater number of layers is also effective.

Examples of a configuration of an insulation part made up of a greater number of layers include:

(1) a configuration in which unexpanded layers and expanded layers are arranged in the following order from the conductor side (i.e., the inside) outward: a first unexpanded layer, a first expanded layer, a second expanded layer, and a second unexpanded layer (here, for example, it is preferable for the first expanded layer and the second expanded layer to have different expansion percentages and for the permittivity of the coating part to change in a step-like fashion); and
(2) a configuration in which unexpanded layers and expanded layers are arranged in the following order from the conductor side outward: a first unexpanded layer, a first expanded layer, a second unexpanded layer, a second expanded layer, and a third unexpanded layer (i.e., a configuration in which an unexpanded layer exists in an intermediate portion of the coating).
A perfluoro resin is used in each of the layers.

At least one layer of the plurality of coating layers must be an expanded layer whose expansion percentage is 40% or greater, and preferably, the expansion percentage of the entire plurality of coating layers is 40% or greater. Thus, preferably, at least one layer of the plurality of coating layers is an expanded layer whose expansion percentage is 42% or greater. The upper limit of the expansion percentage of the entire plurality of coating layers is normally 80%. The upper limit of the expansion percentage of the unexpanded layers is normally 90%.

The expansion percentage is defined by the following equation:

Expansion percentage(%)={1−(ρ/ρ₀)}×100

(ρ: specific gravity of insulation part (coating layer), ρ₀: specific gravity of perfluoro resin)

It is preferable for the perfluoro resin used in the expanded layer(s) to contain a bubble nucleating agent and more preferable for the perfluoro resin to contain a bubble nucleating agent and a foaming aid. Meanwhile, the perfluoro resin used in the unexpanded layer(s) substantially does not contain either of these.

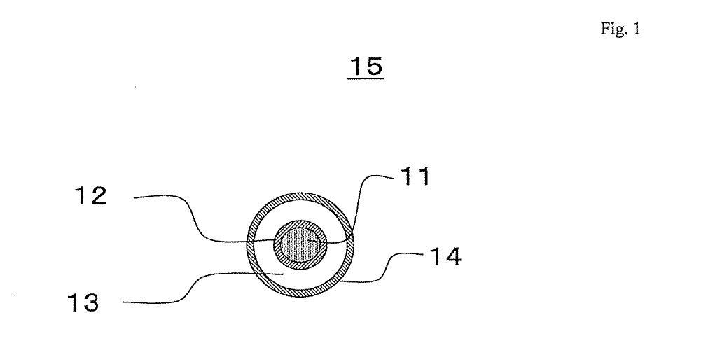

A structure of a foam electric wire 15 according to the present invention will now be explained using FIG. 1, which is a cross sectional schematic view of a foam electric wire 15 according to one configuration of the present invention in which the insulation part comprises three layers.

In one embodiment of the present invention, wherein the insulation part consists of two layers, a configuration of the insulation part is adopted that consists of: a conductor 11, the outer unexpanded layer 14 (outermost layer), and an expanded layer 13 as shown in FIG. 1 (i.e., the layer 12 in FIG. 1 is omitted). This configuration prevents outgassing from and defoaming of an outer side surface of the highly expanded layer at the time forming it, has excellent stability in the capacitance and the outer diameter of an insulating body, and can maintain a uniform, smooth surface state. Though the coating of the outer unexpanded layer 14 must be thick enough to prevent the outgassing and the defoaming, it is preferably on the thin side, as long as the external surface does not undulate. If a cable with a higher expansion percentage is needed, then thickening the outer unexpanded layer 14 is effective to maintain the smooth surface state. The thickness of the outer unexpanded layer 14 is preferably 2%-15% of the thickness of the entire plurality of coating layers, and more preferably is 3%-10% of that thickness.

Moreover, in another embodiment of the present invention, wherein the insulation part consists of two layers, a configuration of the insulation part is adopted that consists of: the conductor 11, an inner unexpanded layer 12, and the expanded layer 13 as shown in FIG. 1 (i.e., the layer 14 in FIG. 1 is omitted). This configuration prevents outgassing from and defoaming of an inner side surface of the highly expanded layer at the time forming it. The thickness of the inner unexpanded layer 12 should be capable of preventing the creation of an irregular gap between the conductor 11 and the expanded layer 13 and providing a sufficient adhesion to the conductor. The thickness of the inner unexpanded layer 12 is 2%-15% of the thickness of the entire plurality of coating layers, and it is more preferably 2%-8% of that thickness.

In addition, in yet another embodiment of the present invention, wherein the insulation part consists of three layers, a configuration of the insulation part is adopted, as shown in FIG. 1, that consists of: the conductor 11; the inner unexpanded layer 12 (innermost layer); the expanded layer 13, which coats the inner unexpanded layer 12; and the outer unexpanded layer 14 (outermost layer), which coats the expanded layer 13.

The perfluoro resins used in the inner unexpanded layer 12 and the outer unexpanded layer 14 substantially contain neither a bubble nucleating agent nor a foaming aid. As a result, in addition to the advantages obtained with the two embodiments described above, a foam electric wire according to this embodiment suppresses the occurrence of a plate-out phenomenon when the resin flows along the tip surface and the die surface.

The thickness of the coating of the outermost part unexpanded layer 14 is, in this case, preferably 2%-15% of the thickness of the entire plurality of coating layers. More preferably, it is 3%-10% of that thickness. The thickness of the coating of the innermost part unexpanded layer 12 is 2%-15% of the thickness of the entire plurality of coating layers, and is more preferably 2%-8% of that thickness.

The perfluoro resin used in the insulation part of the foam electric wire of the present invention mainly consists of a perfluoro polymer, wherein the perfluoro polymer is a copolymer with a melting point of at least 250° C. and consists of at least two types of monomer units selected from the group consisting of a tetrafluoroethylene (TFE) unit, a hexafluoropropylene (HFP) unit, and a perfluoro vinyl ether (PFVE) unit. A content of the perfluoropolymer in the perfluoro resin is normally 90% by weight or more. The abovementioned PFVE is not particularly limited, and may be, for example, a perfluoro unsaturated compound expressed by the general formula CF₂═CF—ORf (wherein, Rf indicates a perfluoro aliphatic hydrocarbon radical).

If the one type of the abovementioned “at least two types of monomer units” is the PFVE unit, then the PFVE unit may be one type only, or it may be two types or more. In the present specification, a perfluoro aliphatic hydrocarbon radical indicates an aliphatic hydrocarbon radical wherein all hydrogen atoms bonded to carbon atoms are substituted by fluorine atoms.

An example of a perfluoro vinyl ether is perfluoro (alkyl vinyl ether) (PAVE). PAVE is a compound expressed by the general formula below (wherein n is an integer in the range of 0-3).

CF₂═CFO(CF₂)ₙCF₃

Examples of PAVE units include a perfluoro (methyl vinyl ether) (PMVE) unit, a perfluoro (ethyl vinyl ether) (PEVE) unit, a perfluoro (propyl vinyl ether) (PPVE) unit, and a perfluoro (butyl vinyl ether) unit; among these, from the viewpoint of crack resistance, a PMVE unit and a PEVE unit are preferable, and a PPVE unit is more preferable.

The abovementioned TFE unit, HFP unit, and PFVE unit are derived from TFE, HFP, and PFVE, respectively, and are parts of the molecular structure of perfluoro polymer. For example, the TFE unit is expressed by —(CF₂CF₂)—.

The composition of the monomers of the perfluoro polymer is not particularly limited, but it is preferably the TFE-based perfluoro polymer, for which the TFE unit is essential.

The TFE-based perfluoro polymer is a copolymer that consists of a TFE unit and either an HFP unit or a PFVE unit, or both, and has a melting point of 250° C. or higher.

The TFE-based perfluoro polymer may consists of a TFE unit and an HFP unit, a TFE unit and a PFVE unit, or a TFE unit, an HFP unit, and a PFVE unit, preferably has a TFE unit:HFP unit:PFVE unit mass ratio of 70-95:0-20:0-10, and more preferably has a mass ratio of 75-95:0-15:0-10.

The TFE-based perfluoro polymer preferably consists of only a TFE unit and an HFP unit, only a TFE unit and a PFVE unit, or only a TFE unit, an HFP unit, and a PFVE unit, and, to obtain satisfactory formability, preferably consists of only a TFE unit, an HFP unit, and a PFVE unit. In the case of the TFE-based perfluoro polymer that consists of only a TFE unit, an HFP unit, and a PFVE unit, the TFE unit:HFP unit:PFVE unit mass ratio preferably is 70-95:4-20:0.1-10.

In the case wherein there are two or more types of PFVE units (e.g., in the case wherein the two types of PFVE units are a PMVE unit and a PPVE unit), the mass of the PFVE units in the abovementioned mass ratios is the total mass of the two or more types of PFVE units.

In the present specification, the abovementioned mass ratios are obtained by using a NMR analyzer to measure the percentage contents of the TFE unit, the HFP unit, and the PFVE unit.

At least one of the coating layers contains a perfluoro polymer having an MFR of 1 to 50 g/10 min and it is acceptable for that coating layer to be either an expanded layer or an unexpanded layer. However, it is more preferable for all of the coating layers to use such a perfluoro polymer.

As a result, a foam electric wire according to the present invention has excellent formability.

It is even more preferable to use a perfluoro polymer having an MFR of 5 to 45 g/10 min and still more preferable to use a perfluoro polymer having an MFR of 10 to 40 g/10 min.

The MFR is measured using a Kayeness melt index tester (model 4002) that complies with the ASTM D 1238-98 standard; specifically, approximately 6 g of the resin (or, polymer) is loaded in a 0.376 in. (inner diameter) cylinder that is held at 372° C.±0.5° C., the resin (or, polymer) is left in the cylinder for 5 min and, after the temperature reaches a state of equilibrium, the resin (or, polymer) is then extruded through an orifice, whose diameter is 0.0825 in. and whose length is 0.315 in., under the load of a 5,000 g piston, and the mass (g) of the resin sampled per unit of time (normally, every 10-60 s) is measured. Each sample is measured three times, and the average value of the amount extruded per 10 min is designated as the measurement value (unit: g/10 min).

The perfluoro polymer has

(1) a melt tension of 0.09 N or greater, and/or
(2) polymer terminals that are substantially only —CF₃,
preferably both of (1) a melt tension of 0.09 N or greater and (2) polymer terminals that are substantially only —CF₃.

When the perfluoro polymer has a melt tension of 0.09N or higher, it is possible to prevent abnormal growth of the foam cell size and reduce the thickness of the insulation layer.

Meanwhile, when the polymer terminals of the perfluoro polymer are substantially only —CF₃, the propagation velocity is high and the transmission loss is small.

Furthermore, when the perfluoro polymer satisfies both conditions, both of the advantages are obtained.

The perfluoro polymer used in the present invention has a melting point of 250° C. or higher. Anything less than 250° C. will cause problems with heat resistance. In particular, the heat resistance of the preformed coated electric wire product may be insufficient. The lower limit of the melting point of the perfluoro polymer is preferably 253° C. and is more preferably 255° C.; furthermore, the upper limit of the melting point of the perfluoro polymer is normally 310° C. and is preferably 300° C.

In the present specification, the melting point of the perfluoro polymer is the peak temperature of the endothermic reaction in a melting curve obtained by hermal measurement using a differential scanning calorimeter (DSC) recited in the ASTM D 4591-87 standard at a rate of temperature rise of 10° C./min.

Using as the abovementioned perfluoropolymer a material with a high melt tension makes it possible for the foam electric wire of the present configuration to exhibit a strong effect. In addition, using a perfluoropolymer with a high melt tension makes it possible to prevent the abnormal increase in the size of the bubbles and thin down the insulation layer. The melt tension value is preferably 0.09 N or greater. It is more preferably 0.10 N or greater. It is even more preferably 0.11 N or greater. The upper limit of the melt tension value is not particularly limited, and may be, 1.0 N.

In addition, as it will be understood from the above description, from the viewpoint of the formability of the unexpanded layers 12, 14, a perfluoropolymer that has high fluidity is preferable. By nature, a perfluoropolymer that has high fluidity has a relatively low molecular weight and therefore tends to have low melt tension; however, a material that has both high melt tension and excellent fluidity would be superior for use as the perfluoropolymer in the unexpanded layers 12, 14. For the unexpanded layer 12, preferable perfluoropolymer characteristics are high melt tension and a melt flow rate (MFR) of 1-50 g/10 min; furthermore, the MFR is more preferably 5-45 g/10 min and is even more preferably 10-40 g/10 min.

From the viewpoint of improving thermostability during formation, basically, the perfluoro polymer preferably does not possess thermally unstable terminal groups at the resin terminals. In other words, the perfluoro polymer preferably have polymer terminals that are substantially only —CF₃. The number of thermally unstable terminal groups is preferably fewer than 50 per 10⁶ carbon atoms, and is more preferably fewer than 20 per 10⁶ carbon atoms.

Examples of unstable terminal groups include a —COF group, a —COOH group, a —CH₂OH group, a —CONH₂ group, and a —COOCH₃ group (below, these are generically called “terminal groups other than the —CF₃ group”). The number of unstable terminal groups is measured by performing infrared absorption spectrometry using an FT-IR Spectrometer 1760X (made by Perkin Elmer Inc.) and then derived by the method recited in U.S. Pat. No. 3,085,083 and Japanese Unexamined Patent Application Publication No. 2005-298659.

A perfluoro resin that has a terminal group other than the —CF₃ group has an inferior dielectric tangent tan δ owing to the polarity of the terminal group.

As mentioned previously, it is preferable for the perfluoro resin used in the expanded layer(s) to contain a bubble nucleating agent and more preferable for the perfluoro resin to contain a bubble nucleating agent and a foaming aid.

A commonly used bubble nucleating agent and a commonly used foaming aid can be used according to a well-established method. The amount of bubble nucleating agent and foaming aid used is normally 10 percent by weight of the perfluoro resin. Examples of types of bubble nucleating agents include inorganic, organic, pyrolytic, and reactive and any of these types is acceptable to use. Specific examples include boron nitride (BN), boric acid, borax, colemanite, talc, metal salts, azo compounds, nitro compounds, hydrazine derivative, semicarbazide compounds, azide compounds, tetrazole compounds, bicarbonate, and carbonate.

There are no particular limitations on the foaming agent (i.e., the gas injected to cause foaming) used. Examples include air, CO₂, N₂, helium, and argon.

The foam electric wire of the present invention can be manufactured using the conventional extruding technique with the abovementioned perfluoropolymer. The extruding technique is preferably a forming technique that uses extruders, which number in accordance with the number of layers, and a single multilayer crosshead. The amount extruded for each layer must be controlled in accordance with each layer's individual thickness. Attendant with the changes in, for example, the thicknesses or the expansion percentage of the layers, the residence time within each extruder differs; consequently, problems such as thermal degradation of the resin tend to occur more in this case than in the extrusion molding of a monolayer. To correct these problems, the above-mentioned perfluoropolymer that has excellent heat resistance, good thermostability, and good fluidity is needed. The expansion percentage can be controlled using methods commonly used in the technical field. For example, the expansion percentage can be controlled by adjusting a rotational speed of an extruder used for the expanded layer(s) and adjusting a pressure difference between an injection pressure of the injected gas (e.g., nitrogen gas) and a pressure inside a barrel of the extruder.

The present invention can be effectively adapted to a relatively fine cable; furthermore, the coating of the foam electrical wire of the present invention can be made relatively thin. Preferably, the size of the foam electrical wire of the present invention is No. 18 AWG or greater. More preferably, it is No. 20 AWG or greater. Even more preferably, it is No. 22 AWG or greater. Preferably, the entire coating thickness is less than 1.5 mm. More preferably, the coating thickness is less than 1.0 mm, and, even more preferably, it is less than 0.8 mm.

### EXAMPLES

The present invention will now be explained in more detail using working examples. However, the present invention is not limited to the working examples.

The expansion percentage was calculated by the equation below in the Examples.

Expansion percentage(%)={1−(ρ/ρ₀)}×100

(ρ: specific gravity of insulation part (coating layer), ρ₀: specific gravity of perfluoro resin)

The outer diameter (OD) of the electric wire was measured using the ODAC 15XY outer diameter measuring instrument (made by Zumbach Electronic AG), which was installed on a commercial production line for an electric wire forming process. The capacitance was measured using the Capac HS capacitance measuring instrument (i.e., the MR20.50HS made by Zumbach Electronic AG).

Measurements of the MFR and the number of unstable terminal groups are conducted as explained previously.

### Examples 1-4, and Reference Example 1

A perfluoropolymer that comprises a TFE unit, an HFP unit, and a PFVE unit and has a composition of 89% TFE, 11% HFP, and 1% PFVE by weight is used as the material for the plurality of layers that constitutes the foam electric wire. The present polymer is a perfluoropolymer with a MFR of 36.5 g/10 min, a melting point of 260° C., a melt tension of 0.11 N, and an unstable terminal group count of 0 per 10⁶ carbon atoms.

A compound that contains the bubble nucleating agent for the expanded layer was manufactured by mixing and kneading 95% perfluoropolymer and 5% boron nitride by weight, wherein BN is the bubble nucleating agent, and then pelletizing the result. Below, the pellets containing the bubble nucleating agent are denoted as BN Masterbatch pellets.

The foam electric wire was manufactured using a coextruding method wherein two extruders were used, one for the expanded layer 13 and one for the outer unexpanded layer 14. Annealed copper wire with an outer diameter of 0.28 mm was used as the conductor 11 (central conductor). A 30 mm extruder equipped with a gas injection system for physical foaming and a mixing screw was used as the extruder for the expanded layer 13. The expansion percentage was controlled by adjusting the rotational speed of the extruder for the expanded layer 13 and the differential pressure between the pressure of a nitrogen gas injection part and the pressure inside the barrel of the extruder.

A pellet mixture with a BN Masterbatch pellet:FEP pellet weight ratio of 1:5 was used as the resin for the expanded layer 13.

A perfluoro resin that does not contain the bubble nucleating agent was used for the outer unexpanded layer 14.

Table 1 shows the evaluation results (i.e., the capacitance, the post-coating outer diameter, and the external appearance) of the obtained foam electric wire. As can be understood from Table 1, a foam electric wire with a satisfactory external appearance, excellent capacitance stability, and excellent outer diameter stability was obtained.

TABLE 1

| | | | | | | | Reference |
|---|---|---|---|---|---|---|---|
| | | | Example | | | | Example |
| | | | 1 | 2 | 3 | 4 | 1 |
| Insulation | Expanded layer 13 wall | mm | 0.301 | 0.367 | 0.403 | 0.453 | 0.395 |
| material | thickness | | | | | | |
| | Thickness percentage of | % | 94.1 | 95.3 | 96.0 | 96.4 | |
| | expanded layer 13 wall | | | | | | |
| | thickness | | | | | | |
| | outer unexpanded layer 14 wall | mm | 0.019 | 0.018 | 0.017 | 0.017 | 0 |
| | thickness | | | | | | |
| | Thickness percentage of outer | % | 5.9 | 4.7 | 4.0 | 3.6 | |
| | unexpanded layer 14 wall | | | | | | |
| | thickness | | | | | | |
| | Expansion percentage | % | 27 | 48 | 56 | 66 | 51 |
| Injection gas pressure | | Bar | 128 | 148 | 158 | 168 | 150 |
| Capacitance | Average value | pf/m | 86.4 | 68.2 | 59.1 | 53.5 | 64.1 |
| | Standard deviation | | 0.32 | 0.25 | 0.24 | 0.22 | 1.1 |
| | Standard deviation/average | % | 0.37 | 0.37 | 0.41 | 0.41 | 1.72 |
| | value × 100 | | | | | | |
| Post coating | Average value | mm | 0.92 | 1.05 | 1.12 | 1.22 | 1.07 |
| outer diameter | Standard deviation | | 0.003 | 0.004 | 0.004 | 0.0045 | 0.01 |
| | Standard deviation/average | % | 0.33 | 0.38 | 0.36 | 0.37 | 0.93 |
| | value × 100 | | | | | | |

| | | | | | |
|---|---|---|---|---|---|
| External appearance, surface | Good | Good | Good | Good | Rough |

### Examples 5-8, and Reference Example 2

The multilayered electric wire consisting of the inner unexpanded layer 12, the expanded layer 13 and the outer unexpanded layer 14 was manufactured from the same polymer as in Example 1 using three extruders.

Annealed copper wire with an outer diameter of 0.75 mm was used as the conductor 11. A 40 mm extruder equipped with a gas injection system for physical foaming and a mixing screw was used as the extruder for the expanded layer 13. The expansion percentage was controlled by adjusting the rotational speed of the extruder for the expanded layer 13 and the differential pressure between the pressure of a nitrogen gas injection part and the pressure inside the barrel of the extruder.

A pellet mixture with a BN Masterbatch pellet:FEP pellet weight ratio of 1:5 was used as the resin for the expanded layer 13.

A perfluoro resin that does not contain the bubble nucleating agent was used for the inner unexpanded layer 12, and the outer unexpanded layer 14.

Table 2 shows the evaluation results (i.e., the capacitance, the post-coating outer diameter, and the external appearance) of the obtained foam electric wire. As can be understood from Table 2, a foam electric wire with a satisfactory external appearance, excellent capacitance stability, and excellent outer diameter stability was obtained.

TABLE 2

| | | | | | | | Reference |
|---|---|---|---|---|---|---|---|
| | | | Example | | | | Example |
| | | | 5 | 6 | 7 | 8 | 2 |
| Insulation | Inner unexpanded layer 12 wall | mm | 0.014 | 0.015 | 0.018 | 0.021 | 0 |
| material | thickness | | | | | | |
| | Thickness percentage of inner | % | 4.7 | 4.9 | 5.8 | 6.8 | |
| | unexpanded layer 12 wall | | | | | | |
| | thickness | | | | | | |
| | Expanded layer 13 wall | mm | 0.27 | 0.27 | 0.27 | 0.26 | 0.31 |
| | thickness | | | | | | |
| | Thickness percentage of | % | 88.7 | 88.2 | 87.1 | 85.2 | |
| | expanded layer 13 wall | | | | | | |
| | thickness | | | | | | |
| | Outer unexpanded layer 14 wall | mm | 0.020 | 0.021 | 0.022 | 0.025 | 0 |
| | thickness | | | | | | |
| | Thickness percentage of outer | % | 6.7 | 6.9 | 7.1 | 8.1 | |
| | unexpanded layer 14 wall | | | | | | |
| | thickness | | | | | | |
| | Expansion percentage | % | 21 | 35 | 42 | 48 | 45 |
| Injection gas pressure | | Bar | 210 | 223 | 234 | 237 | 225 |
| Capacitance | Average value | pf/m | 163 | 155 | 152 | 148 | 64.1 |
| | Standard deviation | | 0.45 | 0.55 | 0.56 | 0.56 | 1.1 |
| | Standard deviation/average | % | 0.28 | 0.35 | 0.37 | 0.38 | 1.72 |
| | value × 100 | | | | | | |
| Post coating | Average value | mm | 1.45 | 1.46 | 1.47 | 1.47 | 1.07 |
| outer diameter | Standard deviation | | 0.007 | 0.008 | 0.009 | 0.009 | 0.02 |
| | Standard deviation/average | % | 0.48 | 0.55 | 0.61 | 0.61 | 1.87 |
| | value × 100 | | | | | | |

| | | | | | |
|---|---|---|---|---|---|
| External appearance, surface | Good | Good | Good | Good | Rough |

A foam electric wire according to the present invention can be used favorably in a variety of electric wire applications because it provides a high propagation velocity and a small transmission loss and minimizes the problems that result from outgassing and defoaming. Examples of applications include plenum twisted pair cables, coaxial cables for CATV, cables for HDMI, coaxial cables for antenna wires in mobile communications, coaxial cables for medical applications, coaxial cables for security, and coaxial cables for broadband applications.

### REFERENCE SIGNS LIST

11 conductor (central conductor)
12 unexpanded layer (inner unexpanded layer)
13 expanded layer
14 unexpanded layer (outer unexpanded layer)
15 foam electric wire

1. A foam electric wire, comprising:
a conductor; and
a plurality of coating layers that coat the conductor and consist of perfluoro resin,
at least one layer of the plurality of coating layers is an unexpanded layer;
at least one layer of the plurality of coating layers is an expanded layer with an expansion percentage of at least 40%; and
at least one layer of the plurality of coating layers contains a perfluoro polymer having an MFR of 1-50 g/10 min,
the perfluoro polymer further having at least one of
(1) a melt tension of 0.09 N or greater, and/or
(2) polymer terminals that are substantially only —CF₃.

2. A foam electric wire according to claim 1, wherein
an expansion percentage of an entirety of the plurality of coating layers is at least 40%.

3. A foam electric wire according to claim 1, wherein
an outermost layer of the plurality of coating layers is an unexpanded layer.

4. A foam electric wire according to claim 3, wherein
a thickness of the outermost layer of the plurality of coating layers is 2%-15% of a thickness of an entirety of the plurality of coating layers.

5. A foam electric wire according to claim 1, wherein
an innermost layer of the plurality of coating layers is an unexpanded layer.

6. A foam electric wire according to claim 1, wherein
the plurality of coating layers consists of three or more coating layers, and
an innermost layer and an outermost layer of the plurality of coating layers are unexpanded layers.

7. A foam electric wire according to claim 1, wherein
all layers of the plurality of coating layers contain the perfluoro polymer.

8. A foam electric wire according to claim 1, wherein
the perfluoro polymer has a melt tension of 0.09 N or greater and polymer terminals that are substantially only —CF₃.

9. A foam electric wire according to claim 1, wherein
the perfluoro polymer consists of a TFE unit and an HFP unit.

10. A foam electric wire according to claim 1, wherein
the perfluoro polymer consists of a TFE unit, an HFP unit, and a PFVE unit.

11. A foam electric wire according to claim 1, wherein
the perfluoro polymer consists of a TFE unit and a PFVE unit.

12. A foam electric wire according to claim 1, wherein
an entirety of the plurality of layers is coextruded.

13. A foam electric wire according to claim 2, wherein
an outermost layer of the plurality of coating layers is an unexpanded layer.

14. A foam electric wire according to claim 13, wherein
a thickness of the outermost layer of the plurality of coating layers is 2%-15% of a thickness of the entirety of the plurality of coating layers.

15. A foam electric wire according to claim 13, wherein
an innermost layer of the plurality of coating layers is an unexpanded layer.

16. A foam electric wire according to claim 8, wherein
the perfluoro polymer consists of a TFE unit and an HFP unit.

17. A foam electric wire according to claim 8, wherein
the perfluoro polymer consists of a TFE unit, an HFP unit, and a PFVE unit.

18. A foam electric wire according to claim 8, wherein
the perfluoro polymer consists of a TFE unit and a PFVE unit.
